(19) United States
(12) Patent Application Publication
(10) Pub. No.: US 2015/0104767 A1
(43) Pub. Date: Apr. 16, 2015

(54) Computer-Based Method for 3D Simulation of Oil and Gas Operations

(71) Applicant: SCHLUMBERGER TECHNOLOGY CORPORATION, Sugar Land, TX (US)

(72) Inventors: Delphine Robineau, Sainte Genevieve des Bois (FR); Khalid Zubair, Croissy Sur Seine (FR); Matthew Loth, Corinda (AU)

(73) Assignee: Schlumberger Technology Corporation, Sugar Land, TX (US)

(21) Appl. No.: 14/383,567

(22) PCT Filed: Mar. 6, 2013
(86) PCT No.: PCT/US2013/029261

§ 371 Date: Sep. 8, 2014

(30) Foreign Application Priority Data
Mar. 8, 2012 (EP) 12158687.9

(51) Int. Cl. G09B 9/00; G06T 13/20; G06T 17/05

(52) U.S. Cl. CPC G09B 9/00; G06T 17/05; G06T 13/20; G06T 2213/00
USPC 434/219

(57) ABSTRACT

The present disclosure relates to a computer-based method for 3D simulation of oil and gas operations. According to an aspect, the method comprises:—selecting from a database comprising data related to a plurality of equipments and a plurality of environments, one environment and at least one equipment;—loading, using a processor, core data and 3D models related to the selected environment and equipment(s), wherein the core data and 3D models are stored in the database;—determining, using the processor, the position of the selected equipment(s) in the selected environment, based on the core data of the equipment(s) and environment;—generating, using the 3D models and the determined position of the equipment(s), a 3D representation of a scene comprising the selected environment and equipment(s);—displaying views and/or animations related to the equipment(s) and/or environment upon request of a user, wherein the views and/or animations are derived from the 3D models.

### FIELD OF THE DISCLOSURE

The present disclosure relates to a computer-based method for 3D simulation of oil and gas operations and a system configured to perform such a method.

### BACKGROUND OF THE DISCLOSURE

Operators in the field of oil and gas operations are trained in a traditional manner. The training comprises training sessions during which the technical specificities of the different equipments are described and their modes of operation explained. Workshop sessions also take place to provide hands-on exposure on how to assemble and disassemble the different pieces of equipments as per manual instructions. A few classroom exercises also help to get a global picture of calculations, job design and procedures. Eventually, a practical training is made on the well site, using the equipments in a real oil and gas environment.

Such traditional training doesn't provide enough exposure of the trainees to the reality of their missions. Explanations based on technical drawings and basic schematics don't provide full understanding of the equipments and, on the other hand, availability to a variety of real equipments for practical training is cost prohibitive. Operators will thus be trained on the job.

In other technical fields, computer-based training has been developed, essentially with applications for soft skill training, like team building and customer services. Further, in the medical field for example, the use of automation and 3D simulation for training and evaluation has been developed. However, none of these methods can be applied to the simulation of oil and gas operations as the diversity of environments and equipments is very extensive in this field.

It is therefore desirable to provide a method for 3D simulation of oil and gas operations that will improve the quality of training for operating equipments in various environments.

### SUMMARY OF THE DISCLOSURE

The present disclosure provides a computer-based method for 3D simulation of oil and gas operations. According to an embodiment, the method comprises:
selecting from a database comprising data related to a plurality of equipments and a plurality of environments, one environment and at least one equipment;
loading, using a processor, core data and 3D models related to the selected environment and equipment(s), wherein the core data and 3D models are stored in the database;
determining, using the processor, the position of the selected equipment(s) in the selected environment, based on the core data of the equipment(s) and environment;
generating, using the 3D models and the determined position of the equipment(s), a 3D representation of a scene comprising the selected environment and equipment(s);
displaying views and/or animations related to the equipment(s) and/or environment upon request of a user, wherein the views and/or animations are derived from the 3D models.

Further, the present disclosure provides a 3D simulation system configured to perform such a method.

The described method and apparatus enable to generate and display a customized 3D scene, in which a high diversity of environments and equipments may be combined.

### LIST OF DRAWING FIGURES

FIG. 1 shows an example of a full 3D simulation system;

FIG. 2 shows an example of a 3D simulation system architecture;

FIG. 3 shows a simplified workflow of different functionalities of the 3D simulation method, according to an embodiment;

FIG. 4 shows a simplified workflow of the 3D interactivity functionality of the 3D simulation method, according to an embodiment;

FIG. 5 shows a simplified workflow of the 3D operations functionality of the 3D simulation method, according to an embodiment;

FIGS. 6A, 6B show examples of the content of a 3D database.

### DETAILED DESCRIPTION OF EMBODIMENTS OF THE DISCLOSURE

In the following, embodiments of a 3D simulation method of oil and gas operations and of a 3D simulation system will be described.

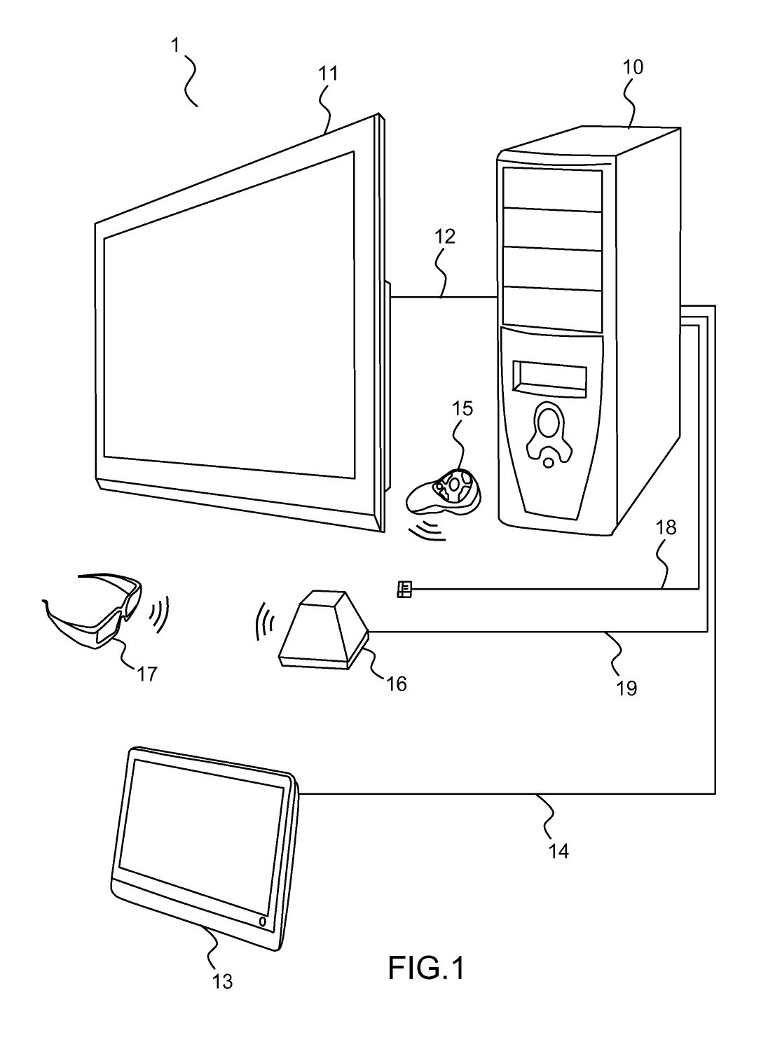

Although the present system will be described using a full 3D Simulator as illustrated in FIG. 1, it is also compatible with a standard 3D set-up and it can be run from a single computer with one or two screens.

As shown in FIG. 1, the full 3D set-up 1 includes a 3D computer 10 having minimum requirements for generating a 3D vision and for managing a 3D screen display 11. The 3D screen display may be a stereo display or a real 3D display. For example, the 3D computer 10 may comprise Microsoft® Windows®7 (32/64-bit) as an operating system, Intel® Core™2 Duo or AMD Athlon™ X2 CPU, 1 GB of system memory, 100 MB free disk space, a NVidia GeForce GTX graphic card.

The 3D Computer 10 is operably connected to the 3D display 11 (such as a 3D TV or a 3D projector), for example, via an HDMI cable 12. The full 3D set-up 1 also includes a second computer 13 used as a user interface. In FIG. 1, the user interface 13 is specified as all-in-one computer with touch screen, connected to the 3D computer 10 via an IP address (such as an Ethernet cable 14 or wifi). For the user interface 13, an alternative to the touch screen would be a keyboard and mouse devices. A joystick or a mouse 15 may be used to drive the 3D Scene. In FIG. 1, the mouse is connected to the 3D computer 10 wireless or via a wire connection 18 to a USB port on the computer.

In FIG. 1, the NVIDIA® System with a 3D Vision HUB 16 and 3D Glasses 17 for 3D visualization is represented. Other visualization means could be used. The 3D vision hub 16 is, for example, connected to the 3D computer 10 via a USB wire 19. Alternatively, it could be integrated into the 3D display equipment 11. A standard 3D set-up would not include 3D visualization means and could use a standard computer and display, therefore a user will still be able to see the 3D scene but in a 2D visualization.

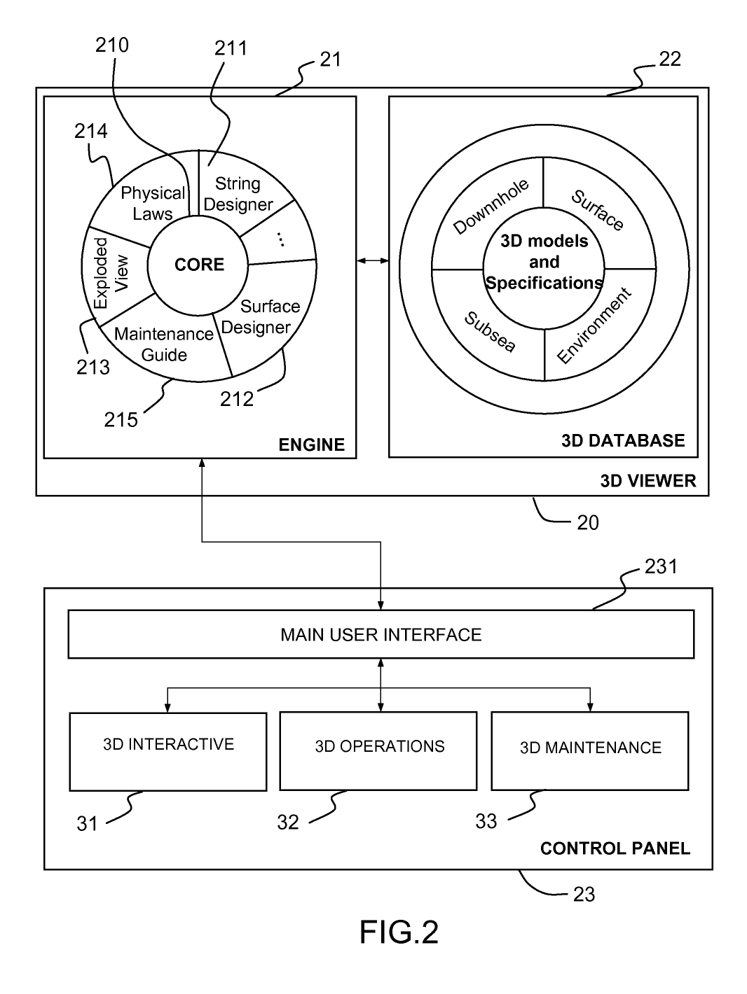

According to an embodiment shown in FIG. 2, the 3D simulation system comprises one executable file run by a processor on each computer, the 3D viewer 20 for the 3D computer (10, FIG. 1), and the control panel 23 for the user computer (13, FIG. 1). Alternatively, in a set-up run from a single computer, the two executable files would be located in the same computer.

The 3D viewer executable file 20 drives the 3D simulation system. It comprises the engine 21 that interacts with the 3D database 22. The engine 21 may be subdivided by the core application 210 and some plug-in applications, such as the string designer 211, the surface designer 212, the exploded viewer 213 and the physical laws 212 applications shown in FIG. 2. These plug-in applications are specific modules that will be loaded when requested during the 3D simulation.

The Core application 210 is giving the basic features of the 3D simulation system while the additional plug-in applications (210-214) are designed to enable the advanced technical specificities of the system.

The core application 210 is the bridge between the 3D database and the plug-in applications 210-214. The functionalities of the core application 210 and its main features comprise, for example, the basic configuration of mobility (keyboard & mouse), the basic management of mobile camera, the basic management of files and folders.

The string designer plug-in application 211 allows the user to dispatch its downhole equipments in the well, along a vertical axis. The features of string designer 211 comprise, for example, the customization of the string by selecting upon request from the user the equipment(s) to be added to the string, the customization of the equipment quantity and position, and the customization of the visualization (such as external or internal views, static or dynamic animations).

In one embodiment the 3D database can be stored remotely on a server. The database may be accessed through a secure connection that requires credentials.

The 3D computer can be a portable station, such as a portable computer. The 3D viewer can be a stereo display or a 3D display. When the 3D viewer is a stereo display, an eclipse method may be used to realize the stereo display.

The physical laws plug-in application 214 allows gathering concepts and formulas, such as for example, formulas to calculate the string weight with regard to the buoyancy forces, formulas to calculate the stretch occurring in the string, algorithms to take into account different initial configurations and conditions, algorithms to adjust total string depth to the reservoir depth and to the seabed equipment, algorithms to validate positioning of equipment with regard to well design (such as blow out preventer (BOP) stack space out, drill stem testing (DST) space out), algorithms to define equipment status with regard to sequence of user actions, algorithms to highlight risks of compatibility between equipments (such as pressure limitations, sequence of operation, and relative position).

The exploded viewer plug-in application 213 allows any 3D part of an assembly to be related to its part number and part name. The exploded viewer 213 features comprise the ability to spread the equipment parts and spares in a 3D space to help the visualization of their main sections and their internal parts. Another feature of the exploded viewer 213 is the 3D localization of a 3D part from its part number or part name by simply selecting it from a list of parts. The list of parts is the bill of materials for each specific equipment. Also, the exploded viewer allows the user to find out the part name and part number by simply clicking on the 3D part.

Other plug in applications are included, such as a surface designer plug-in application 212, to allow user to dispatch its surface equipments on the ground, in a plane. The features of the surface designer 212 comprise, for example, the customization of the surface layout by selecting the equipment(s), the customization of the equipment such as quantity and position in the layout, and the customization of the visualization, such as external or internal views of the equipment, and static or dynamic animations.

Other plug in applications could be used in connection with the 3D simulation system. For example, a maintenance guide application (215) could be used for allowing the user to visualize the maintenance steps of assembly and disassembly for each specific equipment. An additional feature of the maintenance guide application is the display of part number and part name of the 3D parts required during each maintenance step including detailed maintenance instructions in a text format.

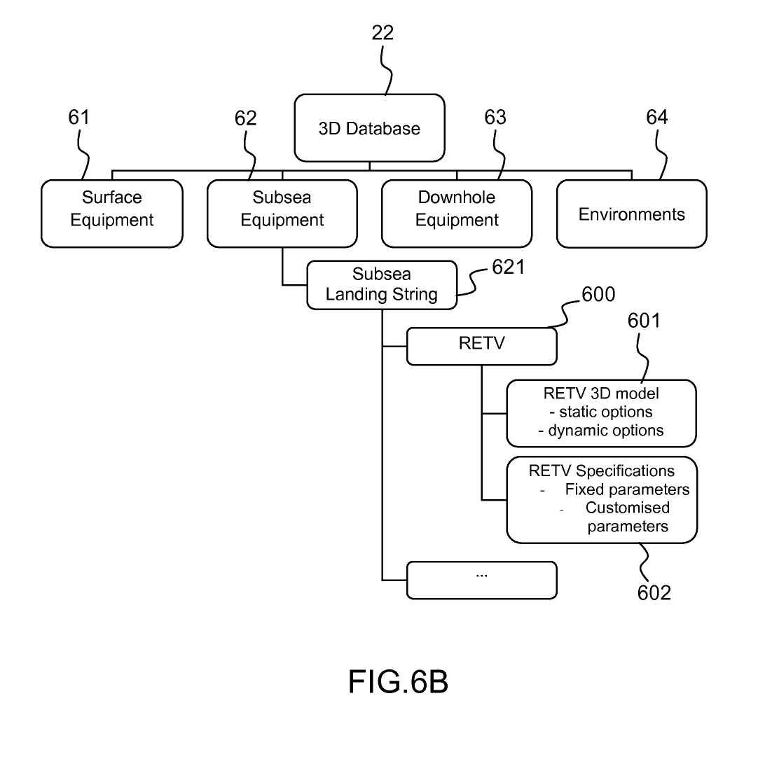

To ensure good sustainability, the 3D simulation system is using a common 3D database of equipment and environment. As such, equipment can be readily modified and updated automatically in the 3D simulation system. The 3D database 22, as shown in FIGS. 2 and 6A, 6B, provides the data related to the equipments and environments. It includes 3D models of the equipments and the environments including the definition of specific views and animations. For example, the 3D database 22 includes 3D models of downhole equipment, such as drill stem testing equipment and perforating equipment. Each of these 3D models are also linked to corresponding specification files that include core data, such as the length, weight, and pressure and temperature limitations. The specification files may also include parameters specified by the user as he or she configures a particular simulation using the 3D simulation system. Example of parameters that the 3D simulation system allows the user to input include, rupture disc pressure selection, initial equipment status, and firmware configuration. As it is well known in the art, equipment status can be whether a ball valve is open or closed, whether a particular flow port is open or closed, whether a particular pre-charged nitrogen pressure is applied etc. For the firmware configuration, the parameters will allow the user to enable or disable the recognition of specific commands and signals as used in the oil and gas industry. For instance, such commands and signals could be acoustic, pressure pulse commands, electrical and or electromagnetical signals.

The 3D models of equipments and environments are required for the generation of the 3D scene that will be used within the 3D simulation functionalities. These 3D models are available in a static view to show the internal components and in a dynamic view to show the operations of the equipment. For instance, the 3D database provides the 3D models of equipment and environment related to well testing operations equipment and environment. Such well testing operations can be divided in surface well testing, downhole well testing and subsea landing string operations. Therefore, for a 3D simulation system for simulating well testing operations, the 3D database may include 3D models of the required surface testing, downhole and subsea equipment.

According to one embodiment of the 3D simulation system, the 3D database (22, FIG. 6A) is, for example, divided in 4 directories including surface equipment 61, subsea equipment 62, downhole equipment 63, and environment 64. Directories 61, 62, and 63 relate to a specific technology while directory 64 relates to the well site environment. More specifically, for a well testing operation, the following technical directories could be included: surface testing 61A, subsea landing string 62A, downhole testing tools 63A and perforating tools 63 B. Each directory has a library of 3D equipment, ready to be loaded in the 3D Scene. The environment directory 64 is divided in sub-directories to deal with the differences between onshore 64B and offshore 64C operations. More directories could be used taking into account reservoir characteristics 64A and well design.

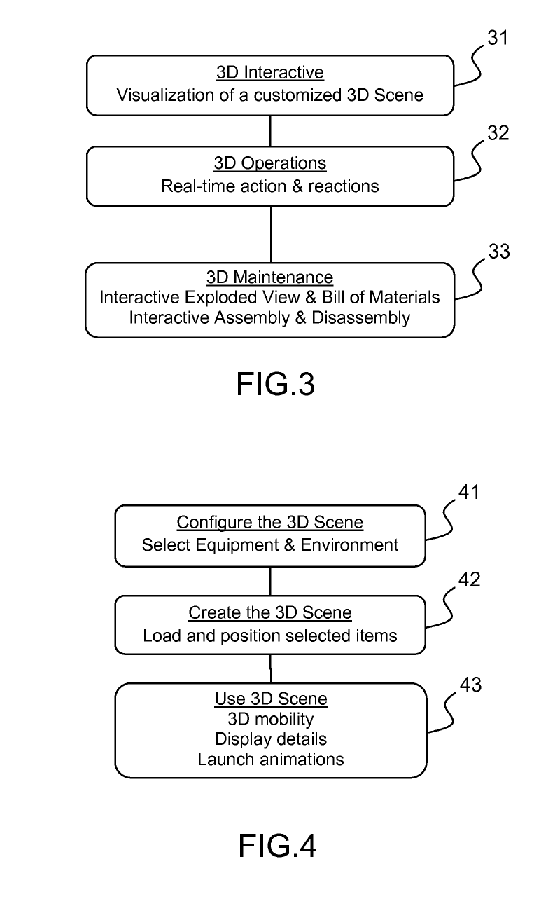

Referring to FIG. 2, the control panel 23 includes the main user interface 231 which is for example a touchable screen with a menu of options that allow the user to select and access directly the functionalities of the 3D simulation System, for example the 3D interactive 31, the 3D maintenance 33 and the 3D operations 32 functionalities further described in FIG. 3. The control panel 23 is operatively in communication with the 3D viewer using a conventional communication method. It should be understood, that the viewer and the control panel also could be co-located inside the same operating system.

Referring to FIG. 3, the 3D interactive functionality 31 allows the user to visualize a customized 3D scene. The 3D operations functionality 32 allows the user to perform an action and observe the real time response (or reaction) of the system in terms of 3D display and parameter management and performance. The 3D maintenance functionality 33 allows the user to access an interactive bill of materials and the assembly or disassembly procedures for the various equipments.

The 3D interactive functionality 31 generates a customized 3D scene and enables the user to move within the 3D Scene for interacting with the selected equipment. The Interactive 3D scene allows the user to gain useful insight into the internal composition of the equipment and its operation. The 3D display allows the user to obtain a quicker and better understanding of the equipment in a safer, virtual manner. Because the 3D simulation system allows for an interactive, virtual experience, knowledge retention also is improved.

The 3D operations functionality 32 acknowledges in real-time the user action and updates accordingly the calculated parameters (pressure, weight) and equipment position and status. Both the parameters and equipment are then synchronously displayed in the 3D scene to allow the user to obtain a visual representation of the desired operation as a whole. The 3D operations functionality provides an opportunity for a safer, longer and more efficient practice and exposure to the operations. The action/reaction principle used in the action simulation functionality also helps to raise awareness on the risks and their potential consequences. The sequence of actions performed by the user can also be tracked to assess knowledge and know-how.

The 3D maintenance functionality 33 enables the user to select the required equipment, to visualize it in an interactive exploded view with the relevant bill of materials and to visualize the maintenance steps of assembly and disassembly. The 3D maintenance functionality provides an opportunity to support maintenance operations. The 3D maintenance could also include means for the generation of a store order for the parts needing replacement. It may also include a build-in check-list to keep track of the identity of each part (part number and batch number) and the progress of the maintenance. It should be understood that the functionalities of the 3D simulation system can be driven from a standard keyboard and mouse, a touch screen, a voice recognition or a combination thereof.

FIG. 4 shows an example of the basic process steps of the 3D interactive functionality of the 3D simulation system, according to an example.

As shown in FIG. 4, the first functionality allows the user to customize the interactive 3D scene by selecting the equipments and the environment from the corresponding 3D database (step 41). For example, the user can select the type of equipment, its position, its quantity and the string environment, creating a virtual visualization of a downhole string used for well testing operations by selecting the equipment 3D model(s) from the downhole equipment directory 63 of the 3D database 22 as shown in FIG. 6A.

The user can also select some default string configuration as a time saving alternative for the most common string designs.

At step 42, the specific plug-in applications together with the core application load the data related to the selected equipment(s) and environment and creates the customized 3D scene. The data include the core data and the 3D models, including the 3D views and 3D animations. The application then determines the position of the selected equipment(s) in the selected environment based on the input of the user and the equipment specifications. For downhole equipment, for example, the 3D models are dispatched along one vertical axis while the surface 3D models are dispatched along a horizontal plane. At step 43, the user can then interact with the equipment by selecting a specific visualization (external or internal views) and equipment specific animations. He can select the level of details displayed for the equipments to better visualize their components. The display options are external views, transparency views and cut views. Equipment specific animations can also be launched to better understand its operation. Examples of typical animations are the opening and closing of a valve, the electronics circuits, and the fluids paths. To make the most of the above features, for a downhole environment 3D scene, the user is mobile within the 3D Scene with one degree of rotating movement freedom around the Z axis, and 2 degrees of displacement movement freedom around the Y and Z axis. For a surface testing 3D scene, the 3D simulation system allows the user to be mobile inside the 3D scene with one degree of rotating movement freedom around the Z axis, and 2 degrees of displacement movement freedom around the X and Y axis. The above movements can be directed by the user using movement control means such as a joystick or mouse.

The same basic steps would apply for the 3D maintenance functionality, wherein the user would select for example the workshop environment.

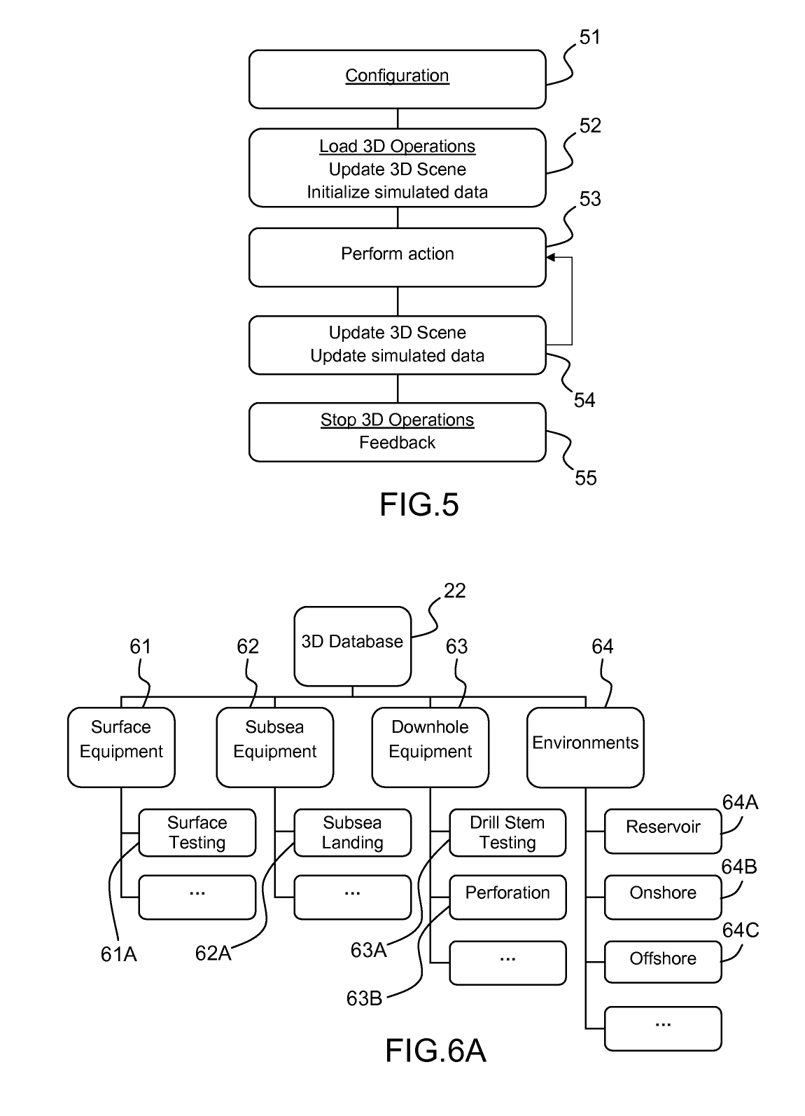

FIG. 5 shows an example of the basic process steps of the 3D operations functionality of the 3D Simulation system.

The 3D operations functionality is a supplementary functionality that allows safe training of the users about well testing equipment and operations in a simulated environment.

As specifically shown in the flowchart FIG. 5, the simulation of operations, begins at step 51 when the user configures the specific 3D Operations application.

The configuration step 51 requests the user to input data into the parameters of the specification files of the relevant equipment. Once done, the specification files are completed and ready to be loaded. To maximize simulation potential, some parameters may be randomly selected by the program within a specified range to ensure realistic values. As an example, for a downhole valve simulation, in step 51, the user will select some customized parameters relating to the environment, such as the depth of the equipment string and the well fluid density. The user will also select the parameters relating to the equipment employed in the string such as programming the downhole valve electronic firmware, and selecting the pressure threshold for the valve as the user will have to do during a real operation.

Another example would be the space out and correlation simulator developed to train the user on equipment positioning and packer setting procedure. The user selects some of the required environment and equipment(s) customized parameters, while the program randomly generates the value for the others, such as the environment parameters of fluid density, seabed depth, reservoir depth, and initial string depth. These parameters will be used by the program to customize the string and to determine its specific data, such as the string weight and equipment position with regards to the target depth.

In step 52, the specification files, including core data and variable parameters will allow the programs to customize and display the 3D Scene accordingly to the user configuration request. In the example given of the space out and correlation simulator, the position, status and number of equipment is generated and displayed on the 3D scene based on information provided during the configuration phase. It also initializes and displays in the 3D scene and/or in the control panel real-time calculated parameters, such as string weight, pressure, that will later vary depending on user actions during the execution of the 3D Operations simulation.

Once the simulator is launched, the user will have to perform one action or a sequence of actions 53 to practice the operation of the equipments. In real-time, the control panel program acknowledges the action performed by the user and it communicates it to the Engine 21. Then, the 3D viewer 22 program synchronously updates the parameters and determines the consequences for the equipment(s) (step 54). The 3D Scene is then updated accordingly to allow the user to visualize the consequences of his actions, on equipment and on the real-time data displayed such as the pressure, temperature, and string weight. More specifically, for the downhole valve operations simulator, the user generates pressure pulses and the programs looks for a pressure trend matching the ones of the firmware library. If one trend is recognized, the firmware parameters are updated and the 3D scene is updated with the corresponding downhole valve operation visualization.

For the space out and correlation simulator, the user is driving the string up and down, rotating it in order to set the packer and put the guns in front of the target zone. Depending on the action performed, the displayed data (weight, stick up length) is updated and displayed in real-time. Other equipment specific parameters are also managed in real-time to determine string behavior and correctly display in the 3D scene the equipments status and position, i.e. to set packer, the string should be in tension with full up weight displayed in the 3D scene or if packer is not set, the jar cannot closed.

In step 55, all the sequences of action performed by the user may be tracked and stored. Feedback may be given to the user to assess his knowledge and know his performances.

While the invention has been described with respect to a limited number of embodiments relating to well testing operations and equipment, those skilled in the art having benefit of the present disclosure will appreciate that other embodiments can be devised that do not depart from the scope of the invention as disclosed herein.

Therefore, the scope of the invention should be limited only by the attached claims.

1. A computer-based method for 3D simulation of oil and gas operations, the method comprising:
selecting from a database comprising data related to a plurality of equipments and a plurality of environments, one environment and at least one equipment;
loading, using a processor, core data and 3D models related to the selected environment and equipment(s), wherein the core data and 3D models are stored in the database;
determining, using the processor, the position of the selected equipment(s) in the selected environment, based on the core data of the equipment(s) and environment;
generating, using the 3D models and the determined position of the equipment(s), a 3D representation of a scene comprising the selected environment and equipment(s);
displaying views and/or animations related to the equipment(s) and/or environment upon request of a user, wherein the views and/or animations are derived from the 3D models.

2. The method according to claim 1, in which a predetermined set of equipments can be selected.

3. The method according to claim 1, in which determining the position of the selected equipment(s) is further based on an input by the user.

4. The method according to claim 1, further comprising:
loading, using the processor, initial values of parameters related to the selected equipment(s) and environment;
capturing an action from a user on one of the selected equipment(s) and environment;
determining, using the processor, the new values of the position and of the parameters related to the equipment(s) and environment resulting from the captured action;
generating an updated 3D representation of the scene based on the new values of the position and parameters.

5. The method according to claim 4, wherein at least part of the initial values of the parameters are configured by the user.

6. The method according to claim 4, wherein at least part of the initial values of the parameters are randomly configured.

7. The method according to claim 4, further comprising displaying simultaneously the captured action and the 3D representation of the scene.

8. The method according to claim 4, further comprising storing a sequence of captured actions and new values of position and parameters resulting from each of the actions.

9. A 3D simulation system configured to perform a method according to claim 1, wherein the system comprises:
A processor;
A space memory to store the database;
A user interface operatively connected to the processor;
A stereo or 3D display.

10. The system according to claim 9, wherein the database is stored remotely on a server.

11. The system according to claim 10, wherein access to the database is done through a secure connection wherein credentials are required.

12. The system according to claim 9, wherein the system is a portable station.

13. The system according to claim 9, wherein the stereo display is done by eclipse method.

14. A computer-based method for 3D simulation of oil and gas operations, the method comprising:
selecting from a database comprising data related to a plurality of equipments and a plurality of environments, one environment and at least one equipment;
loading, using a processor, core data and 3D models related to the selected environment and equipment(s), wherein the core data and 3D models are stored in the database;
determining, using the processor, the position of the selected equipment(s) in the selected environment, based on the core data of the equipment(s) and environment;
loading, using the processor, initial values of parameters related to the selected equipment(s) and environment;
generating, using the 3D models and the determined position of the equipment(s), a 3D representation of a scene comprising the selected environment and equipment(s);
capturing an action from a user on one of the selected equipment(s) and environment;
determining, using the processor, the new values of the position and of the parameters related to the equipment(s) and environment resulting from the captured action;
generating an updated 3D representation of the scene based on the new values of the position and parameters; and
displaying views and/or animations related to the equipment(s) and/or environment upon request of a user, wherein the views and/or animations are derived from the 3D models.

15. The method according to claim 12, wherein at least part of the initial values of the parameters are configured by the user.

16. The method according to claim 12, wherein at least part of the initial values of the parameters are randomly configured.

17. The method according to claim 12, further comprising displaying simultaneously the captured action and the 3D representation of the scene.

18. The method according to claim 12, further comprising storing a sequence of captured actions and new values of position and parameters resulting from each of the actions
